(19) United States
(12) Patent Application Publication
(10) Pub. No.: US 2024/0346403 A1
(43) Pub. Date: Oct. 17, 2024

(54) SYSTEMS AND METHODS FOR USING MACHINE LEARNING TO ASSOCIATE AN ACTOR WITH AN OPERATION

(71) Applicant: Divisions Maintenance Group, Newport, KY (US)

(72) Inventors: Manik SINGLA, Bengaluru (IN); Ankit JAIN, Bangalore (IN); Deepak MITTAL, Delhi (IN)

(21) Appl. No.: 18/300,988

(22) Filed: Apr. 14, 2023

(51) Int. Cl. G06Q 10/0631

(52) U.S. Cl. CPC G06Q 10/063112; G06Q 10/063114

(57) ABSTRACT

A computer-implemented method for associating at least one actor with an operation using machine learning includes receiving actor data comprising at least one actor parameter corresponding to at least one operation parameter of the operation, determining a weightage score for each actor parameter using a trained machine-learning model, determining a suitability score for each actor based on the weightage scores, generating a preliminary group of suitable actors including each actor having a suitability score satisfying a predetermined threshold, and transmitting, to a portal viewable by at least one of the actors, a selection of at least one actor from the preliminary group of suitable actors to be associated with the operation. One or more of the operation parameters may be predictive of a predetermined distribution of operations across the plurality of actors.

### TECHNICAL FIELD

Various embodiments of this disclosure relate generally to machine learning based techniques for associating an actor with an operation and, more particularly, to systems and methods for selecting one or more actors to perform one or more operations using machine learning.

### BACKGROUND

Currently, maintenance facilitators generally rely on human experience and relationships to assign maintenance tasks to maintenance providers. This method of assigning tasks can lead to inefficiencies in assigning tasks, such as a failure to assign tasks to new providers based on a lack of experience with the new provider. Such inefficiencies can lead to, for example, incumbent providers receiving a larger than optimal portion of assignable tasks, giving the incumbent providers leveraged bargaining position and reducing organizational efficiencies.

This disclosure is directed to addressing one or more of the above-referenced challenges. The scope of the current disclosure, however, is defined by the attached claims, and not by the ability to solve any specific problem. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for associating at least one actor with at least one operation by using a trained machine learning model.

In one aspect, a computer-implemented method for associating at least one actor of a plurality of actors with an operation using machine learning is disclosed. The method includes receiving actor data including at least one actor parameter corresponding to at least one operation parameter of the operation, determining a weightage score for each of the at least one actor parameters for each of the at least one actors using a trained machine-learning model, determining a suitability score for each of the at least one actors based on the weightage scores, generating a preliminary group of suitable actors including each of the at least one actors having a suitability score satisfying a predetermined threshold, and transmitting, to a portal viewable by at least one of the actors, a selection of at least one actor from the preliminary group of suitable actors to be associated with the operation. One or more of the at least one operation parameters is predictive of a predetermined distribution of operations across the plurality of actors. The trained machine-learning model has been trained based on historical actor data and historical evaluations associated with the historical actor data to learn associations between the historical actor data and the historical evaluations, so that the trained machine-learning model is configured to use the learned associations to determine each weightage score based on the actor data.

In another aspect, a system for associating at least one actor of a plurality of actors with an operation using machine learning is disclosed. The system includes a memory having processor-readable instructions stored therein, and one or more processors configured to access the memory and execute the processor-readable instructions, which when executed by the one or more processors configures the one or more processors to perform a plurality of functions. The function include receiving actor data including at least one actor parameter corresponding to at least one operation parameter of the operation, determining a weightage score for each of the at least one actor parameters for each of the at least one actors using a trained machine-learning model, determining a suitability score for each of the at least one actors based on the weightage scores, generating a preliminary group of suitable actors including each of the at least one actors having a suitability score satisfying a predetermined threshold, and transmitting, to a portal viewable by at least one of the actors, a selection of at least one actor from the preliminary group of suitable actors to be associated with the operation. One or more of the at least one operation parameters is predictive of a predetermined distribution of operations across the plurality of actors. The trained machine-learning model has been trained based on historical actor data and historical evaluations associated with the historical actor data to learn associations between the historical actor data and the historical evaluations, so that the trained machine-learning model is configured to use the learned associations to determine each weightage score based on the actor data.

In yet another aspect, a computer-implemented method for associating at least one actor of a plurality of actors with an operation using machine learning is disclosed. The method includes receiving actor data including at least one actor parameter corresponding to at least one operation parameter of the operation, determining a weightage score for each of the at least one actor parameters for each of the at least one actors using a trained machine-learning model, determining a suitability score for each of the at least one actors based on the weightage scores, with the suitability score for each actor including a summation of the weightage scores for each of the actor parameters of that actor, generating a preliminary group of suitable actors including each of the at least one actors having a suitability score satisfying a predetermined threshold, with the predetermined threshold being a percentage of a maximum possible value of the suitability score, and transmitting, to a portal viewable by at least one of the actors, a selection of at least one actor from the preliminary group of suitable actors to be associated with the operation. The weightage score for at least one of the actor parameters is based on an intent of the operation, the intent including at least one of cost, speed, and quality. The weightage score for each of the actor parameters is a numerical value in a predetermined range, and the predetermined range of the weightage score for a first of the actor parameters is different than the predetermined range of the weightage for a second of the actor parameters. One or more of the at least one operation parameters is predictive of a predetermined distribution of operations across the plurality of actors. The trained machine-learning model has been trained based on historical actor data and historical evaluations associated with the historical actor data to learn associations between the historical actor data and the historical evaluations, so that the trained machine-learning model is configured to use the learned associations to determine each weightage score based on the actor data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for training and/or using a machine learning model to assign a task to a provider using a trained machine learning model, according to one or more embodiments.

FIG. 2 depicts a schematic maintenance environment, in which environment a system for training and/or using a machine learning model to assign a task to a provider could be deployed.

FIG. 3 depicts a flowchart of an exemplary process of training a machine learning model to associate an operation with an actor.

FIG. 4 depicts a flowchart of another exemplary process of using a trained model to associate an operation with an actor.

FIG. 5 depicts a flowchart of an exemplary method for processing raw input data for use by a machine learning model, according to one or more embodiments.

FIG. 6 depicts a simplified functional block diagram of a computer that may be configured as a device for executing the methods disclosed herein, according to one or more embodiments.

FIG. 7A depicts an exemplary table of operation parameters and corresponding actor parameters utilized in the processes of FIGS. 4-6.

FIG. 7B depicts the table of FIG. 7A with the addition of weightage scores for each actor parameter.

### DETAILED DESCRIPTION OF EMBODIMENTS

According to certain aspects of the disclosure, methods and systems are disclosed for associating an actor with an operation by using a trained machine-learning model on actor data associated with the operation. An actor may be, for example, an entity having one or more technicians capable of performing various services. An operation may be, for example, a maintenance operation generated by an operation generator, such as an occupant, owner, or tenant (collectively referred to hereinafter as an “operation owner”) of an industrial, commercial, or residential site. It may be desirable for occupants, owners, or tenants of sites to generate maintenance operations which are then associated with one or more actors for performance. Further, it may be desirable for the associations between actors and operations to be evaluated to improve the future associations between actors and operations. However, conventional techniques for generating and evaluating the association between an actor and an operation may be lacking. For example, such evaluations may rely on fallible human perceptions, and may not adequately consider factors to ensure optimal distribution of operations across an entire pool of actors. Accordingly, improvements in technology relating to automatically associating actors with operations, and to automatically evaluating such associations, would be beneficial.

As will be discussed in more detail below, in various embodiments, systems, and methods are described for receiving actor data including at least one actor parameter, determining a weightage score for each of the actor parameters using a trained machine-learning model, determining a suitability score for each of the at least one actors, generating a preliminary group of suitable actors having a suitability score satisfying a predetermined threshold, and transmitting a selection of at least one actor from the preliminary group of suitable actors to be associated with the operation. By training a machine-learning model, e.g., via supervised or semi-supervised learning, to learn associations between historical actor data and historical evaluations, the trained machine-learning model may be usable to generate and/or evaluate associations between one or more actors and one or more operations.

Reference to any particular activity is provided in this disclosure only for convenience and not intended to limit the disclosure. A person of ordinary skill in the art would recognize that the concepts underlying the disclosed systems and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, terms such as “actor data” or the like generally encompass data associated with one or more actors having various expertise at performing operations at an industrial, commercial, and/or residential facility. As described herein, actor data may include actor parameters, which may include various information relevant in evaluating the suitability of the actors to perform one or more operations.

As used herein, the term “historical actor data” may be actor data associated with historical operations that have been completed or otherwise terminated. In some embodiments, the historical actor data may be grouped or bucketized into one or more groups based on characteristics of the operation from which the historical actor data was gathered. For example, the historical actor data may be labeled based on a particular type of job completed in the operation (e.g., electrical, mechanical, plumbing, landscaping, etc.) The historical actor data may be labeled based on location of the task to be completed or a location of the entity requesting the task (e.g., the operation generator 120). Historical actor data may be labeled as routine work or non-routine work. Historical actor data may be labeled based on an urgency of the tasks within the historical actor data. For example, the historical actor data may be labeled on a sliding scale of urgency (e.g., 1 to 5, etc.) In some embodiments, the historical actor data may be labeled to include an operation generator-defined service type (e.g., electrical, mechanical, plumbing, landscaping, etc.) In some embodiments, the historical actor data may be labeled based on a budget or price tolerance of the operation generator.

As used herein, the term “maintenance facilitator” may refer to, for example, a person, organization, or entity that provides, facilitates, offers, or contracts for performance of one or more operations, e.g., as defined by one or more work orders, scopes of work, or the like.

As used herein, the term “operation generator” may refer to, for example, a customer, client, or patron of a maintenance facilitator. The operation generator may be, for example, a business, a corporation, or other entity, a person, or other individual. The operation generator may generate one or more work orders (e.g., replace a group of lightbulbs in a parking lot). The operation generator may comprise a name, which name may be indicative of an operation generator size (number of employees, market capitalization, etc.), an operation generator location (e.g., a zip code), an operation generator defined service type, or other factors (e.g., the amount of maintenance work they perform every year (as measured by total maintenance expenditures, local maintenance expenditures, man-hours, the length of time they have been generating work orders, and etc.)

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or semi-supervised training may be employed. For example, supervised learning may include providing training data and labels corresponding to the training data, e.g., as ground truth. Any suitable type of training may be used, e.g., stochastic, gradient boosted, random seeded, recursive, epoch or batch-based, etc.

Conventionally, fulfilling an operation request involves receiving a scope of work (or “work order”) including operation data describing one or more operations from an operation generator (e.g., a customer) and assigning the scope of work to one or more actors to complete the one or more operations. The scope of work may be reviewed and/or edited by an employee for accuracy before it is assigned to the one or more actors. The work order may be assigned to the one or more actors based on the identity of the operation generator, the type of work in the work order, the expected cost of the work order, and other factors associated with the particular operations therein. Also, the work order may be assigned to the one or more actors based on work history of each of the one or more actors, for example, the number of operations completed, the type of operations completed, the speed and accuracy of completed operations, a physical location of the actor (or a technician thereof) as compared with the work site, etc. However, this conventional process may be time consuming, complex, and/or inaccurate. Furthermore, the conventional process generally lacks any meaningful concern for distribution of operations over a pool of actors to ensure a robust infrastructure of actors for performing future operations.

In an exemplary use case of the present disclosure, a machine-learning model may be trained to evaluate one or more actor parameters and one or more operation parameters to generate and/or evaluate an association between an actor and an operation. Training data (e.g., historical actor and/or operation data) and ground truth (e.g., historical evaluations associated with the training data) may be used to train the machine learning model, e.g., to develop associations between the training data and the ground truth.

Presented below are various aspects of machine learning techniques that may be adapted to generate an evaluation of an actor-to-operation association by using a trained machine-learning model on actor data. As will be discussed in more detail below, machine learning techniques adapted to generating an evaluation of at least one task may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

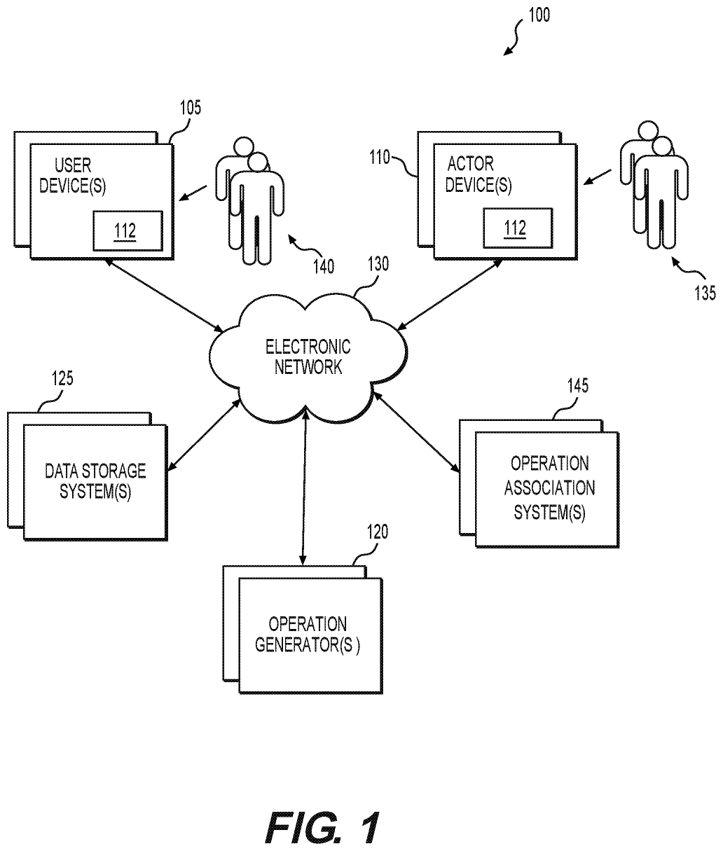

FIG. 1 depicts an exemplary environment 100 that may be utilized with techniques presented herein. One or more user devices 105 used by one or more users 140 (e.g., an operation generator, an operation owner, an employee, etc.), one or more actor devices 110 used by one or more actors 135 (which may include employees, technicians, etc.), one or more operation generators 120, one or more operation association system(s) 145, and one or more data storage systems 125 may communicate across an electronic network 130. As will be discussed in further detail below, the operation association system 145 may communicate with one or more of the other components of the environment 100 across electronic network 130 in order to train and/or use a machine learning model to associate one or more operations with one or more actors 135 by applying learned associations to actor data and/or other data.

In some embodiments, components of the environment 100 are associated with a common entity, e.g., a maintenance contracting service provider, or the like. In some embodiments, one or more of the components of the environment is associated with a different entity than another. The systems and devices of the environment 100 may communicate in any arrangement. As will be discussed herein, systems and/or devices of the environment 100 may communicate in order to generate, train, and/or use a machine-learning model to generate and/or evaluate an association between one or more operation and one or more actors, among other activities.

The one or more user device(s) 105 and the one or more actor device(s) 110 may comprise an input/output device (e.g., a touchscreen display, keyboard, monitor, etc.) and may be associated with the user 140, e.g., a user associated with one or more of generating, training, or tuning a machine-learning model for generating, obtaining, or analyzing operation or actor data, and/or associating one or more operations to one or more actors 135.

The user device 105 may be configured to enable the user 140 to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105. In some embodiments, the electronic application(s) may be associated with one or more of the other components in the environment 100. For example, the electronic application(s) may include one or more of system control software, system monitoring software, software development tools, etc.

The user device 105 may be configured to provide access to a virtual portal 112 through which the user 140 can access the operation generator 120 to generate work orders for operations, generate available operations from those work orders, view computer-generated associations between the operations and actors, accept an actor for performing an operation, and the like. The virtual portal 112 may be implemented in one or more electronic application(s), e.g., a program, plugin, browser extension, etc.

In some embodiments, the actor device 110 may also be configured to provide access to the virtual portal 112 through which any of the one or more actors 135 can view available operations, submit applications for open operations, view computer-generated associations between the operations and that actor, accept operations for which that actor has been associated, and the like.

The data storage system 125 may include a server system, an electronic data system, computer-readable memory such as a hard drive, flash drive, disk, etc. In some embodiments, the data storage system 125 includes and/or interacts with an application programming interface for exchanging data to other systems, e.g., one or more of the other components of the environment. The data storage system 125 may include and/or act as a repository or source for actor data, operation data, and the like as described herein.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the operation association system 145 may generate, store, train, and/or use a machine-learning model configured to associate one or more actors with one or more operations. In some embodiments, the at least one task may then be assigned to at least one technician corresponding to the one or more actors, e.g., automatically, by the user 140, or by a combination thereof. The operation association system 145 may include a machine-learning model and/or instructions associated with the machine-learning model, e.g., instructions for generating a machine-learning model, training the machine-learning model, using the machine-learning model, etc. The operation association system 145 may include instructions for retrieving evaluation data and/or actor data, adjusting evaluation data and/or actor data, e.g., based on the output of the machine-learning model, and/or operating a display to output evaluation data and/or actor data, e.g., as adjusted based on the machine-learning model. The operation association system 145 may include training data, e.g., historical actor and/or operation data, and may include ground truth data, e.g., evaluation and/or association data.

The training data may include historical operation data which may include historical scopes of work. Additionally, the training data may include data related to the urgency of a particular scope of work for historical operations (e.g., historical operations that have been completed, etc.); name data (e.g., operation generator identity (“Store Mart”)); location (e.g., zip code); service type (e.g., landscaping, mechanical, electrical, etc.); description of an operation (e.g. “change lightbulbs in a parking lot”, “replace an outlet in an office space”, “install a light fixture”, “mow a lawn”, “fill a pot hole in a parking lot”, “replace a faucet in a restroom”, etc.); lists of sub-operations to be completed when completing an operation; equipment lists required for completing an operation, and other operation data associated with an operation.

In some embodiments, a system or device other than the operation association system 145 is used to generate and/or train the machine-learning model. For example, such a system may include instructions for generating the machine-learning model, the training data and ground truth, and/or instructions for training the machine-learning model. A resulting trained-machine-learning model may then be provided to the operation association system 145.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn correlations/associations between operation data and actor data, such that the trained machine-learning model is configured to determine an association in response to the input operation data and/or actor data based on the learned correlations/associations.

In some instances, different samples of training data and/or input data may not be independent. For example, some data associated with various actors and operations may be related, e.g., for a given geographical area, for particular types of work, or due to a likelihood that a given actor will routinely perform the same type of work, or that a given actor will perform most or all of their work within a particular radius of a given location. Thus, in some embodiments, the machine-learning model may be configured to account for and/or determine relationships between multiple samples, e.g., to associate operations efficiently.

Although depicted as separate components in FIG. 1, it should be understood that a component or portion of a component in the environment 100 may, in some embodiments, be integrated with or incorporated into one or more other components. For example, a portion of a display may be integrated into the user device 105 or the like. In another example, the operation association system 145 may be integrated the data storage system 125. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to determine an association of one or more operation to one or more actors by using a trained machine learning model are discussed in further detail in the processes below. In the following processes, various acts may be described as performed or executed by a component from FIG. 1, such as the operation association system 145, the user device 105, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

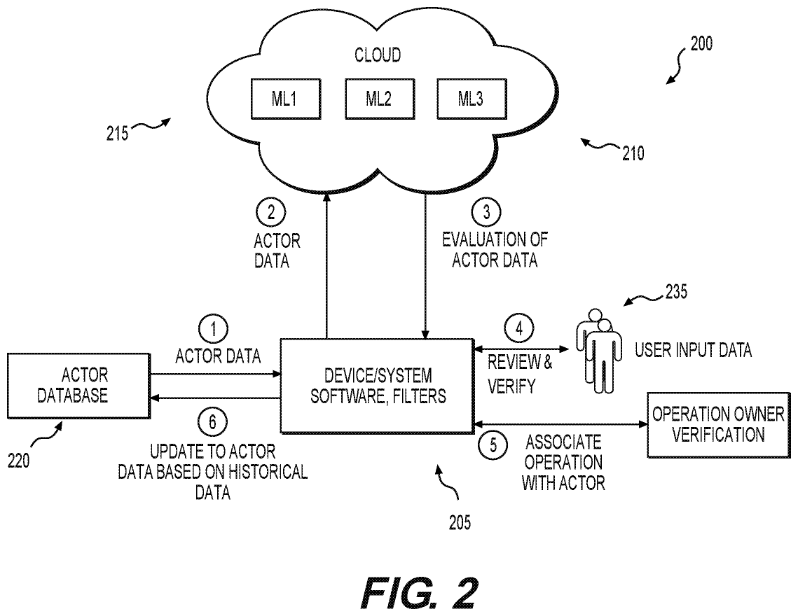

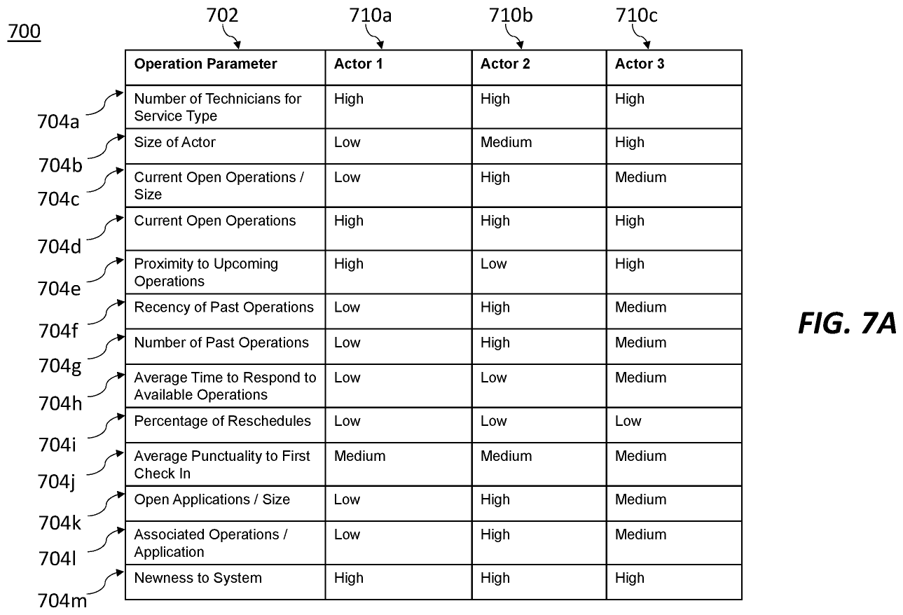

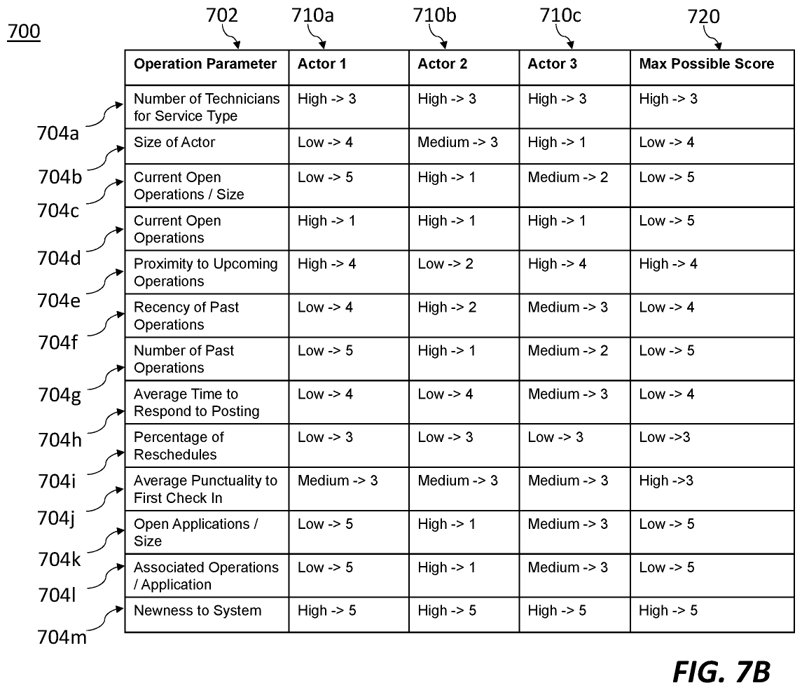

FIG. 2 illustrates an exemplary workflow schematic 200 for using and/or training a machine-learning model to automatically determine an association between one or more operations and one or more actors, such as the actor 135 of FIG. 1, using one or more trained machine learning models. The schematic 200 includes a device (or system) 205 that may be communicatively coupled to an electronic network 210 (e.g., a cloud network). The electronic network 210 may be configured to execute one or more machine learning algorithms 215 to evaluate one or more operations and automatically associate such operations(s) with one or more actors. Actor data, including one or more actor parameters, may be (1) received from an actor database 220, such as data storage system(s) 125 of FIG. 1. As described in greater detail herein with reference to FIGS. 7A and 7B, the actor parameters may include various data relating to actors that is relevant in evaluating the suitability of the actors to perform one or more operations. The actor data within the actor database 220 may be obtained from a variety of sources. Some actor parameters may be input directly by the actors themselves, e.g., the actors 135 of FIG. 1. Other actor parameters may be input by a user 235 (e.g., an employee or an operation owner). Other actor parameters may be automatically generated by one or more systems, such as the device 205, based on historical performance and evaluation of the actors.

In some embodiments, particularly where certain actor parameters are input by the actors, users, or are otherwise obtained from non-normalized sources, the device 205 may preprocess the actor data before transmitting (2) the actor data to the electronic network 210. The preprocessed and/or filtered actor data is then in a form accepted by the machine learning algorithms 215.

The electronic network 210 may include and/or provide access to one or more machine learning algorithms 215. In various embodiments, the machine learning algorithms may be hosted or implemented on any suitable machine. In the exemplary workflow depicted in FIG. 2, the machine learning algorithms are distributed in a cloud implementation that includes multiple servers ML1, ML2, ML3, etc. The machine learning algorithms 215 may have been trained on historical actor data and historical evaluations associated with the historical actor data to learn associations between the historical actor data and the historical evaluations.

The machine learning algorithms 215 may then generate weightage scores for each parameter of the actor data by applying learned associations between historical actor data and the historical evaluations to the input actor data to generate the weightage scores. The electronic network 210 may then transmit (3) the weightage scores associated with the actor data to the device 205 for further distribution, use, and/or processing.

In some embodiments, the device 205 may provide (4) the actor data to the user 235 (e.g., an employee or an operation owner) for review and verification, e.g., prior to employing and/or re-employing the machine learning algorithms 215. In some embodiments, the user 235 may verify the information within the actor data and edit the data as appropriate. The user may return the edited actor data to the device 205 as user input data to be transmitted to the machine learning algorithms 215.

In some embodiments, the device 205 may be configured to obtain operation data including operation parameters for one or more particular operations. Operation parameters may include, for example, information relating to user-input or automatically generated characteristics of an operation. Examples of operation parameters are described herein with reference to FIGS. 7A and 7B. The operation data may further include one or more operation priorities, such as “speed” for an operation that must be performed by a predetermined deadline, “cost” for an operation that must be performed for the lowest possible (or reasonable) cost, or “quality” for an operation that must be performed to a predetermined level of quality. The operation data may be received at the device 205 or within the electronic network 210. The operation data may be obtained be the device 205 from a client, operation owner, or the like.

In some embodiments, one or more of the device 205 and the electronic network 210 may determine and/or transmit (5) an association of an operation to an actor based on the actor data and the operation data. In some embodiments, the association may be based at least in part upon the actor data, an evaluation, or the like. In some embodiments, the user 235 may review the automatically determined association and may provide user oversight with respect to the evaluation and/or association of the operation to the actor. In some embodiments, the user input may change the association of the operation from one actor to another actor.

In some embodiments, the operation owner may provide input to the actor data or the evaluation generated based on the actor data (e.g., verify that the evaluation is appropriate). This actor verification data may be used by the device 205 to develop more accurate machine learning models to better associated operations to actors, and/or may be used to update or adjust (6) the actor data prior to re-employing the machine learning algorithms 215 in order to update evaluation(s) based on the operation owner's feedback.

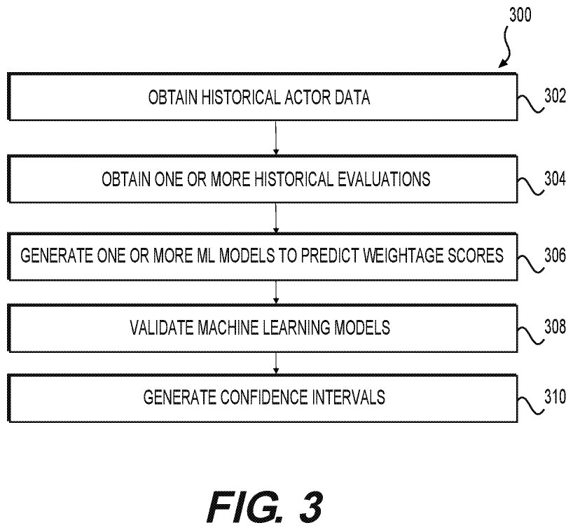

FIG. 3 illustrates an exemplary process 300 for training a machine learning model, such as the machine learning algorithms 215 of FIG. 2, to evaluate at least one operation, e.g., using the electronic network 130 of FIG. 1. At step 302, the historical actor data (as defined herein) may be obtained. The historical actor data may be obtained, for example, from a database of historical actor data (e.g., the actor database 220 of FIG. 2). The historical actor data includes historical attributes of one or more actors, such as information relating to past performances and/or associations of operations of those actors.

In some embodiments, a certain portion (e.g., a percentage (10%, 20%, etc.)) of the historical actor data may be used as test data to test the machine learning models developed using the methods described herein. This test data may be reserved separately from the historical actor data that may be used to train the models and the test data may be used to develop confidence intervals in the data as explained in greater detail herein.

At step 304, one or more historical evaluations and/or historical associations that relate the historical actor data to historical operation data may be obtained. The historical evaluations may include evaluations of the one or more actors in the historical actor data (e.g., an actor's historical number of technicians for a service type, an actor's historical size, an actor's historical number of open operations relative to the actor's size, an actor's historical number of open operations, an actor's historical proximity to operations, an actor's historical distribution of operations over time, an actor's historical average time to respond to available operations, an actor's historical percentage of reschedules, an actor's historical punctuality in performing operations, an actor's historical number of open applications relative to the actor's size, an actor's historical number of associated operations per submitted application, and historical trends to any of the foregoing). In some embodiments, obtaining the one or more historical evaluations may include parsing actor information from the one or more historical evaluations (e.g., finding an actor's historical punctuality for operations performed on an emergency basis). In some embodiments, a certain portion (e.g., a percentage (10%, 20%, etc.)) of the historical evaluation data may be used as test data to test the machine learning models. This test data may be reserved separately from the historical evaluation data used to train the models and may be used to develop confidence intervals in the data as explained in greater detail herein.

At step 306, the historical actor data and the historical operation data may be used to generate and/or train one or more trained machine learning models that may be used, for example, to predict weightage scores for each parameter of the actor data. The trained machine learning model(s) may be trained to learn associations between the historical actor data and the historical operation data, so that the trained machine-learning model(s) is configured to use the learned associations to generate the weightage scores for each parameter of the actor data based on the actor.

At step 308, the machine learning model(s) generated in step 308 may be validated and/or one or more confidences may be generated based on the machine learning model(s). The machine learning model(s) may be validated, for example, using data which has not been previously presented to the machine learning model(s). For example, the machine learning model(s) may be validated using test data reserved for validation (e.g., the test data described above with respect to the historical actor data, historical evaluations, and actor data discussed herein). The test data may have been randomly split from the historical actor data, for example. In some embodiments, there may be a specific holdout data set from the historical actor data.

In some embodiments, at step 310, one or more confidence intervals or confidence levels may be generated. The confidence intervals or levels may, for example, measure the uncertainty in the evaluations generated using test data on the one or more machine learning model(s) generated at step 308. The confidence interval or level may quantify, for example, an uncertainty of an evaluation, a repeatability of a particular actor parameter, or an accuracy of an evaluation of one or more actors. The confidence level may provide a lower and upper bound of the evaluation. In some embodiments, the confidence interval may provide a likelihood of a particular evaluation. In some embodiments, confidence levels may be generated using one or more separate machine learning tasks. In an exemplary use case, the confidence interval or level may be used to determine particular criteria for which a particular trained model is more accurate. The test data may include different portions of test data that correspond to different, isolated actor parameters. By evaluating the trained model with test data from each actor parameter in isolation, the system may determine confidence, accuracy, and/or other factors for the trained model for each actor parameter without undue influence from other actor parameters. In this manner, one or more actor parameters may be determined for which the trained model is more efficient, accurate, or the like. Examples, of actor parameters that may be used in this manner include actor punctuality, actor size, actor proximity to an operation, and other actor parameters discussed herein with reference to FIGS. 7A and 7B.

FIGS. 7A and 7B illustrate a table or database (hereinafter “table 700”) of actor parameters used to associate one or more actors to one or more operations. Table 700 includes a column 702 of operation parameters 704a-704m relevant to a specific operation. Table 700 further includes one or more actor columns 710a-710c including actor data associated with respective actors. In the illustrated example, actor column 710a includes actor data associated with “Actor 1”; actor column 710b includes actor data associated with “Actor 2”; and actor column 710c includes actor data associated with “Actor 3”. Though three actors are shown in the illustrated example, those skilled in the art would appreciate that essentially an unlimited number of actor columns representing respective actors may be used. The actor data associated with each actor includes one or more weightable actor parameters that correspond, in a one-to-one relationship, to the one or more operation parameters 704a-704m. The actor parameters may be used to automatically determine which actors to display available operations to, automatically distribute operations in an optimal manner among the actors, and automatically determine the suitability of actors for performing operations.

As shown in FIG. 7A, each of the actor parameters is assigned a value, such as “High”, “Medium”, or “Low” based on known information about each of the actors as that information relates to an intent (e.g. speed, cost, quality) of an operation. The values are assigned to each actor parameter based on the correspondence between the respective operation parameter and the characteristics of each actor. For example, as shown in FIG. 7A, Actor 1 has a value of “Low” associated with the operation parameter “Size of Actor” 704b, indicating that the number of technicians employed by Actor 1 is a relatively poor match to a desired intent of the subject operation. As will be described in greater detail below, if the intent of the operation is cost, an actor employing a relatively large number of technicians may not be desirable, on the assumption that a high number of technicians necessitates large overhead, which ultimately results in increased cost passed on to the operation owner. The values of the actor parameters may be assigned manually by a user (e.g. the user 140 of FIG. 1) or automatically by various processor-based systems/devices (e.g. the system 205 of FIG. 1), which may implement the use of machine learning to assign the value as described herein. The values of the actor parameters may be updated (again, either manually by a user or automatically by a system/device) whenever an actionable event occurs. Actionable events may include, for example, an actor applying to an available operation, an actor being associated with an operation, an actor performing an operation, an actor rescheduling an operation, an actor cancelling an operation, an actor adding a new technician, and other events that warrant a change in any of the actor parameters. As a result of updating the actor parameters, the actor parameters accurately reflect the present state of each actor to optimize association of one or more actors with one or more operations.

As shown in FIG. 7B, each of the actor parameters is assigned a weightage score based on the assigned value. The weightage scores may be assigned manually by a user (e.g. the user 140 of FIG. 1) or automatically by various processor-based systems/devices (e.g. the system 205 of FIG. 1), which may implement the use of machine learning to assign the value as described herein. In particular, the weightage scores may be assigned by a machine learning model trained using historical actor data, historical operation data, and/or historical evaluations associated with the historical actor data to learn associations between the historical actor data and the historical operation data, so that the trained machine-learning model is configured to use the learned associations to determine each weightage score based on the actor data.

In some embodiments, the weightage score may be a numerical within a predetermined range (e.g. a range of 1 to 5, 1 to 4, or 1 to 3). For example, for certain actor parameters, a value of “High” may correspond to a weightage score of “5”, whereas a value of “Low” may correspond to a weightage score of “1”. For other actor parameters, “Low” may correspond to the highest numerical weightage score. FIG. 7B also includes column 720, indicating the maximum possible weightage score for each of the operation parameters. The maximum possible weightage score corresponds to a highest level of correlation between the actor parameter and the corresponding operation parameter.

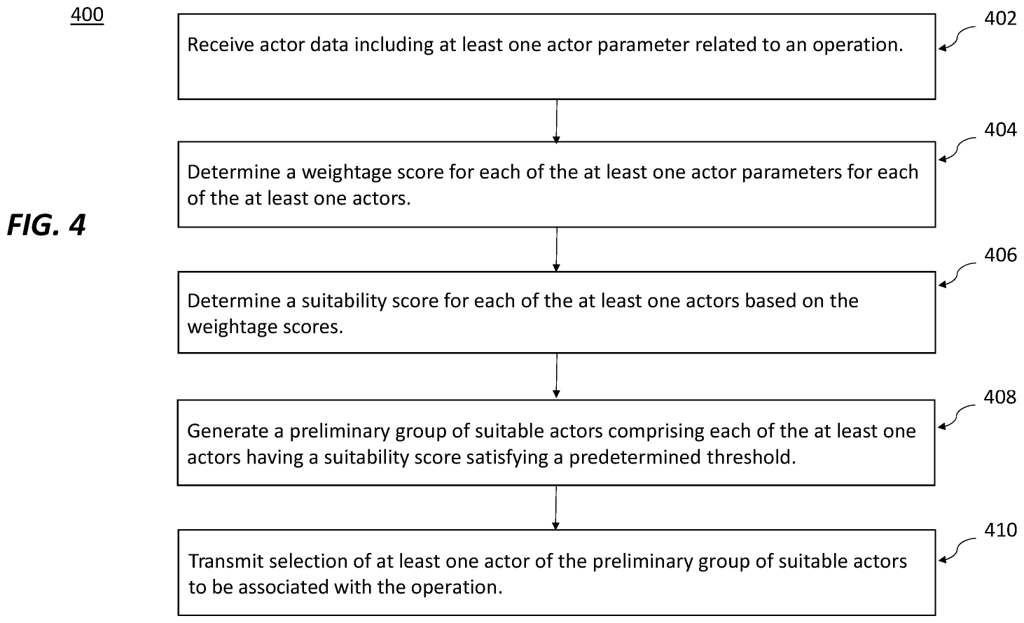

The correspondence for any or all of the weightage scores may not be as simple as “High” to “5” and “Low” to “1”. Rather, the systems and processes of the present disclosure may use various methods, such as machine learning, to determine optimal weightage scores for the actor parameters based on specific intents of the operation (e.g. cost, speed, quality) and/or an optimized distribution of work across actors. For example, even if an actor is employs an appropriate number of technicians (operation parameter 704b) for a given operation, resulting in a corresponding actor parameter value of “High”, the weightage score need not necessarily be a high value if it is desired to distribute work between actors of different sizes. Further description of the assignment of weightage scores to the actor parameters is provided herein, particularly with reference to the method 400 of FIG. 4. In other words, in some embodiments, weightage scores may be dynamically updated, e.g., based on operation parameters, user preferences, and/or other factors.

Operation parameters 704a-704m and the associated actor parameters shown in FIG. 7A represent a non-exhaustive set of data that may be utilized by the systems and methods of the present disclosure. Specific types of actor data utilized may vary according to the demands of a particular operation, preferences of the operation owner, availability of actor data, and various other factors. Details of each of the operation parameters 704a-704m and the corresponding actor parameters shown in FIGS. 7A and 7B are described as follows:

“Number of Technicians for Service Type” (operation parameter 704a) refers to the number of technicians that an actor employs who have a skillset commensurate with the operation. For example, if the operation relates to a plumbing repair, “Number of Technicians for Service Type” means the number of technicians capable of performing the plumbing repair. This parameter may have varying degrees of granularity. For example, plumbing repair could be further broken down into more specific operations, with a higher relevance being given to an actor parameter that matches or approximates the more specific operation. Generally, a weightage score assigned to this parameter favors an actor with more technicians with commensurate service experience, with a higher level of granularity further improving the weightage score.

“Size of Actor” (operation parameter 704b) refers to the number of technicians that an actor employs, whether skilled specifically in the subject operation or not. This parameter may be used as a proxy for predicting an actor's cost, speed, and quality. For example, an actor with a relatively large number of technicians may be predicted to be able to perform the operation promptly and competently due to the availability of that actor's technicians. Conversely, an actor with a relatively large number of technicians may be predicted to cost more because of the larger administrative overhead associated with maintaining a large force of technicians. As such, the weightage score assigned to this parameter may favor an actor with a relatively large number of technicians when an intent for the operation is speed and/or quality, whereas the weightage score applied to this parameter may favor an actor with a relatively small number of technicians when an intent for the operation is cost.

“Current Open Operations/Size” (operation parameter 704c) refers to a number of open (i.e. yet to be started) and/or in-progress operations currently associated with the actor, relative to the size of the actor (i.e. number of technicians employed by the actor). This parameter may be presented as a ratio, with a lower ratio (i.e. a low number of open/in-progress operations relative to actor size) indicating that the actor is under-utilized, and a higher ratio (i.e. a high number of open/in-progress operations relative to actor size) indicating that the actor is over-utilized. The weightage score assigned to this parameter may favor actors that are under-utilized in order to maintain an optimal distribution of work across all actors.

“Current Open Operations” (operation parameter 704d) refers to the number of open/in-progress operations currently associated with an actor. Unlike “Current Open Operations/Size”, this parameter does not take into account the size (i.e. number of technicians) of the actor. Rather, the purpose of this parameter is to ensure that operations are optimally distributed between multiple actors, and to ensure that large actors do not take substantially all of the available operations. Otherwise, smaller actors may not be associated with a sufficient number of operations to justify their use of the platform. To those ends, the weightage score assigned to this parameter favors actors already associated with a relatively low number of open/in-progress operations. Conversely, large actors that could effectively take enough operations to create an imbalance in work distribution are less favored. Note that the purpose and result of this parameter is not to penalize large actors, but rather to ensure that large actors are not disproportionately favored in the aggregate simply due to their size. In some embodiments, the weightage score may be at least partially based on a liquidity term that measures a fraction or percentage of available actors that are associated with an operation in a predetermined time period (e.g., a month). The liquidity term may help the system judge how well work is being distributed between actors, and flag actors that are receiving either too few or too many operations relative to a predetermined ideal distribution of work. The weightage scores of actor(s) may be adjusted to influence selection of actors that would result in a work distribution closer to the ideal distribution of work.

“Proximity to Upcoming Operations” (operation parameter 704e) refers to the geographic proximity of the subject operation to other pending/in-progress operations associated with an actor. This parameter predicts that an actor who is already associated with at least one operation near the subject operation will have greater incentive to timely perform the subject operation, and perhaps do so at reduced cost. Proximity may be defined as a predetermined distance, for example within a five mile radius of the subject operation. The weightage score assigned to this parameter favors actors with other operations near the subject operation.

“Recency of Past Operations” (operation parameter 704f) refers to how recently an actor has performed one or more operations through the platform. For example, the timestamps of the last three operation performed by an actor may be analyzed, and may serve as a proxy for speed with which that actor will perform the subject operation. This parameter favors actors who have more recently performed operations, particularly when an intent of the operation is cost.

“Number of Past Operations” (operation parameter 704g) refers to the number of operations an actor has completed in a past predetermined time period, such as the past three months. The weightage score assigned to this parameter favors actors who have completed a relatively high number of operations where an intent of the operation is quality. Conversely, to encourage engagement with less active actors, the weightage score assigned to this parameter may favor actors with less past operations completed where an intent of the subject operation is cost. Thus, this parameter may be used to ensure that operations are optimally distributed among the actors.

“Average Time to Respond to Available Operations” (operation parameter 704h) refers to the historical average time an actor takes to apply to operations posted to the platform (e.g. to the portal 112 of FIG. 1). If an actor has a history of quickly replying to available operations, this parameter may favor that actor for operations which have an intent of speed (e.g. emergency operations) to avoid delay. Historical, fast response times indicate that the actor is actively monitoring the platform for newly posted operations, so it is reasonable to infer that that actor would also respond quickly to future available operations. Conversely, this parameter may disfavor from speed-intent operations those actors who historically take a long time to respond to available operations.

“Percentage of Reschedules” (operation parameter 704i) refers to the percentage (or other fraction) of operations for which the performing actor rescheduled the time of performance. This parameter may be ascertained from the last several operations (e.g. the last 3-10 operations) performed by an actor. The weightage score for this parameter favors actors with low rescheduling rates, particularly for operations which have an intent of speed and/or quality.

“Average Punctuality to First Check In” (operation parameter 704j) refers to the percentage (or other fraction) of operations for which the performing actor began performance of an operation within an initially scheduled window. For example, this parameter may represent a fraction of times that an actor arrived to perform an operation between one hour before and one half hour after the initially schedule time. This parameter may be ascertained from the last several operations (e.g. the last 3-10 operations) performed by an actor. The weightage score for this parameter favors actors who are punctual (i.e., have a high percentage of arriving within the initially schedule window), particularly for operations which have an intent of speed.

“Open Applications/Size” (operation parameter 704k) refers to the number of open applications for operations that an actor has relative to the size of that actor. The weightage score for this parameter favors actors who have low numbers of applications relative to the size of that actor.

“Associated Operations/Application” (operation parameter 704l) refers to the number of operations associated with an actor relative a number of operations for which that actor applied for (i.e. submitted a posting in response to). Ideally, all actors would have a relatively high fraction of associated operations relative to operations applied for, indicating that actors are only applying to available operations to which they are among the most suited to perform. If this fraction falls below a predetermined threshold (e.g. if an actor is actually associated with less than 30%-40% of the operations for which that actor applies), an actor is either applying for too many operations for which that actor is not well suited, or the system is incorrectly appraising the suitability of that actor when displaying available operations. The weightage score for this parameter disfavors actors who have a low fraction of associated operations relative to operations applied for.

“Newness to System” (operation parameter 704m) refers to a length of time an actor has been using the system. In some embodiments, this parameter is binary—e.g. an actor is characterized as either “old” or “new”. An actor may be characterized as “old”, for example, after that actor has been using the system for one month or more. This parameter favors actors who are old, especially for operations for which speed and/or quality are an intent. Conversely, new actors tend to be associated with operations for which speed and/or quality are not priorities, which allows new actors to familiarize themselves with the system before being relied on to perform operations for which speed and/or quality are an intent. In some embodiments, this parameter may also disfavor new actors where quality is an intent, so that operations which require quality are not performed by inexperienced actors.

Referring now to FIG. 4, an exemplary process 400 is illustrated for associating one or more actors with one or more actors with one or more operations, e.g., by utilizing a trained machine-learning model such as a machine-learning model trained according to process 300 discussed above. At step 402, the process 400 includes receiving, by user 140 and/or the data storage system 125, actor data related to one or more operations, e.g., from actor database 220 and/or from another source. As described herein with reference to FIGS. 7A and 7B, the actor data may include at least one actor parameter indicative of the actors' aptitude and/or suitability for performing the operation. At a more granular level, each of the at least on actor parameters represents a quantifiable attribute that can be used to assess the actors' suitability to perform the operation, according to an operation parameter, operation intent, and/or a predetermined distribution of work across actors.

In some embodiments, at least one of the actor parameters corresponds to at least one operation parameter that is indicative of a predetermined distribution of operations across a plurality of actors. An example of an operation parameter meeting this criteria is “Size of Actor” (operation parameter 704b of FIGS. 7A and 7B). By utilizing operation parameters predictive of the predetermined distribution of operations across a plurality of actors, process 400 ensures that individual actors are not over-utilized or under-utilized. Otherwise, certain actors, particularly those of a relatively large size (i.e. employing a relatively number of technicians) may enjoy a systemic advantage in being associated with operations simply because they have the necessary infrastructure and volume of technicians to compete for a disproportionate number of operations. Conversely, relatively small actors may receive a disproportionately small number of operation due to their size, despite being perfectly capable of performing more operations. Thus, the use of operation parameters that are predictive of a predetermined distribution of operations across a plurality of actors can correct for bias or overreliance based on an actor's size in determining the operations to associate with that actor. In addition to “Size of Actor”, other operation parameters that are predictive of the predetermined distribution of operations across a plurality of actors include, but are not limited to: “Current Open Operations/Size” (operation parameter 704c of FIGS. 7A-7B); “Open Applications/Size” operation parameter 704k of FIGS. 7A-7B); and “Associated Operations/Application” (operation parameter 704l of FIGS. 7A-7B).

While the foregoing description of operation parameters predictive of the predetermined distribution focused on the attribute of actor size, it will be understood by those skilled in the art that attributes other than actor size may be predictive of the predetermined distribution of operations. For example, “Average Time to Respond to Posting” (operation parameter 704h of FIGS. 7A-7B) may be predictive of the predetermined distribution of operation because actors who more consistently (or automatically) check for new available operations, and subsequently apply for a relatively high number of operations, may be disproportionately favored. More generally, operation parameters predictive of the predetermined distribution are those parameters that can be used to compensate for systemic imbalances in the manner that operations are assigned to actors in conventional systems.

In some embodiments, actor data is only received at step 402 for those actors who have submitted a posting (i.e. an offer to perform an available operation, typically including a cost at which the actor is willing to perform the operation) to perform the subject operation via the portal 112 (see FIG. 1). In some embodiments, actor data for one or more particular actors may automatically be received even if those actors did not submit an application. That is, the process 400 may recognize those actors as atomically relevant whether or not they submitted an application.

Referring still to FIG. 4, at step 404, the process 400 includes determining a weightage score for each of the at least one actor parameters for each of the at least one actors. The determination at step 404 may be made using a trained machine-learning model, such as a machine-learning model trained according to process 300 discussed above. Step 404 may be performed, for example, at the data storage system 125 or in the electronic network 130. The weightage score for each of the actor parameters may be based on how closely that actor parameter corresponds to the associated operation parameter. The weightage score may be provided as any suitable metric for quantifying the correspondence of actor parameters to operation parameters. In some embodiments, the weightage score may be a numerical value on a predetermined scale. For example, the predetermined scale may be whole numbers 1 through 5, inclusive, with a value of “1” representing no correspondence to the associated operation parameter and a value of five “5” representing identity (or a highest possible level of correspondence) to the associated operation parameter. In other embodiments, the weightage score may be a binary, with a value of “0” corresponding to positive correspondence to the associated operation parameter and a value of “1” corresponding to negative correspondence to the associated operation parameter.

As noted above, determining the weightage score may be performed using a trained machine learning model. The trained machine-learning model may have been trained based on: (i) historical actor data, and (ii) historical evaluations associated with the historical actor data, such as via the process 300 discussed above. The trained machine learning model may have been trained to learn associations between the historical actor data and the historical evaluations, so that the trained machine-learning model is configured to use the learned associations to generate the weightage scores based on the actor data.

In some embodiments, the weightage scores may be used as parameters in an assignment model for determining suitability of actors for an input operation, such that the use of the trained machine-learning model to generate the weightage score results in a tuning of the assignment model to the particular operation parameters for an input operation. In this manner, the assignment model may be configured to provide actor selections that are specifically tailored to an input operation.

At step 406, the process 400 includes determining a suitability score for each of the at least one actors based on the weightage scores. Step 406 may be performed, for example, at the data storage system 125 or in the electronic network 130. The suitability score for each actor may be, in some embodiments, a summation of the numerical values of the weightage scores for each of the actor parameters. Thus, an actor would have a maximum possible suitability score if each of the actor parameters of that actor had a weightage score representing the highest level of correspondence to the respective operation parameters. Conversely, an actor would have a minimum possible suitability score if each of the actor parameters of that actor had a weightage score representing the lowest level of correspondence to the respective operation parameters.

As illustrated in FIG. 7B at column 720, the maximum possible weightage score for each actor parameter need not be consistent across all operation parameters. That is, the predetermined range of the weightage score for a first of the actor parameters may be different than the predetermined range of the weightage for a second of the actor parameters. For example, the maximum weightage score for the actor parameter corresponding to “Number of Technicians for Service Type” (operation parameter 704a) is “3”, whereas the maximum weightage score for the actor parameter corresponding to “Size of Actor” (operation parameter 704b) is “4”. As such, operation parameter 704b has a more significant effect on the suitability score than operation parameter 704a, because the weightage score for operation parameter 704b accounts for a larger percentage of the suitability score.

In some embodiments, a multiplier may be applied to the weightage score of one or more of the actor parameters to increase or decrease the effect of that actor parameter on the suitability score. For example, if the operation owner or machine learning model deems one of the actor parameters to be more important, relative to other actor parameters, in predicting successful fulfillment of the operation, a multiplier may be applied to that actor parameter. As such, the multiplied actor parameter would weigh more heavily in determination of the suitability score than the other actor parameters.

Referring again to FIG. 4, at step 408, the process 400 includes generating a preliminary group of suitable actors. The preliminary group may include each of the actors for which the suitability score determined at step 406 exceeds a predetermined threshold. The predetermined threshold corresponds to a minimum level of competency that the operation owner or machine learning model deems acceptable for an actor to perform the operation. The predetermined threshold may represent a fraction (or percentage) of the maximum possible suitability score for an actor. For example, if the maximum possible suitability score is 55, the predetermined threshold may be 33 (or 60%), indicating that the sum of the weightage scores must equal or exceed 33 for an actor to be included in the preliminary group of suitable actors. The preliminary group of suitable actors may be stored at the data storage system 125 or in the electronic network 130.

In some embodiments, if no actors satisfy the predetermined threshold, the predetermined threshold may be is automatically adjusted (e.g. automatically decreased) until at least one actor satisfies the adjusted predetermined threshold. For example, the predetermined threshold may be adjusted from 33 (or 60%) to 27.5 (or 50%) if no actor has a suitability score of at least 33. In some embodiments, automatically adjusting the predetermined threshold may be performed iteratively until a desired number of actors satisfy the adjusted predetermined threshold. For example, if no actor satisfies the adjusted predetermined threshold of 27.5, the predetermined threshold may be adjusted again to 22 (a 10% decrease), and so on. In some examples, the predetermined threshold may be adjusted until a predetermined number of actors (e.g. at least two actors) satisfy the adjusted predetermined threshold, so that the preliminary group of suitable actors includes at least two actors.

In some embodiments, if no actors satisfy the predetermined threshold, a predetermined number of actors with the highest suitability scores are automatically selected for inclusion in the preliminary group of suitable actors. For example, the actors with the two highest suitability scored may be selected, so that the preliminary group of suitable actors includes two actors.

In some embodiments, if no actors satisfy the predetermined threshold, one or more actor parameters and/or operational parameters may be negated. For example, if no actors satisfy the predetermined threshold, the analysis may be repeated without the “Newness to the System” parameter. Such negation may be iterated for additional parameters until at least one actor satisfies the predetermined threshold. In some embodiments, there may be a predetermined priority for negating parameters. In some embodiments, the priority of negating parameters may be based on the determined weightages.

In some embodiments, the adjustment of the predetermined threshold and negation of one or more parameter may be performed alternatingly, in tandem, or in any suitable fashion. In some embodiments, a trend in the change in suitability scores across multiple iterations may be determined and implemented in order to determine adjustments and/or negations of parameters likely to result in at least one actor meeting the predetermined threshold.

In some embodiments, if the number of actors satisfying the predetermined threshold exceeds a predetermined quota, the predetermined threshold is automatically adjusted (e.g. automatically increased) so that the preliminary group of suitable actors includes no more than the predetermined quota. The predetermined quota may be used to limit the number of actors in the preliminary group of suitable actors to a number that is practicable for ultimately selecting one or more of the actors to associate with the operation (as will be described hereinafter with respect to process 500),

As step 410, the process 400 includes transmitting, to a portal viewable by at least one of the actors in the preliminary group of suitable actors, a selection of at least one actor from the preliminary group of suitable actors to be associated with the operation. The selected actor, i.e. the actor associated with the operation, can thus utilize the portal (e.g. the virtual portal 112 accessible from the actor device 110 of FIG. 1) to receive an alert, message, or the like indicating that the selected actor has been associated with the operation. Furthermore, the selected actor(s) may use the portal (e.g. the virtual portal 112 accessible from the actor device 110 of FIG. 1) to transmit confirmation back to the system/device (e.g. operation association system 145) accepting the selection. For example, the alert may be transmitted to the portal 112 so as to be viewable only by the actor(s) selected to be associated with the operation, and the confirmation may be input into the portal 112 as user input by the selected actor and communicated back to the operation association system 145.

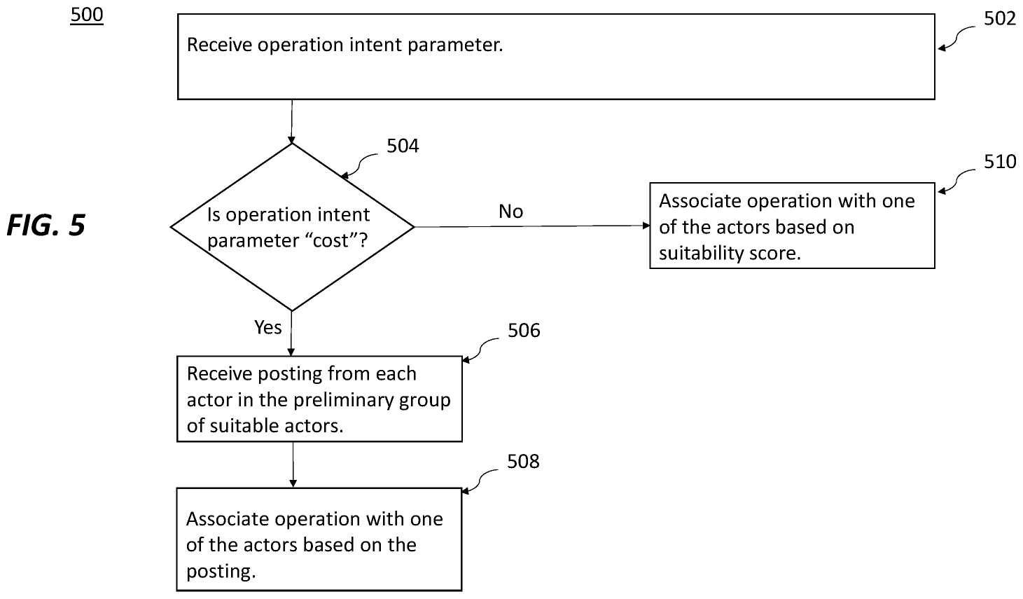

Selecting the actor(s) from the preliminary group of suitable actors to be associated with the operation may be performed by the operation owner (e.g. manually), automatically by a processor-based system/device (e.g. the system 205 and/or the machine learning model 215 of FIG. 2). In some embodiments, the preliminary group of suitable actors may be transmitted to the portal so as to be accessible by the user 140 (see FIG. 1). The user 140, via the portal, may manually select one of the actors from the preliminary group of suitable actors to be associated with the operation, and transmit the selection back to the system/device (e.g. operation association system 145) via the portal. In other embodiments, one or more of the actors is automatically selected from the preliminary group of suitable actors to be associated with the operation, as is described herein with reference to FIG. 5.

In some embodiments, method 400 may further include receiving customer preference data of the operation owner. Customer preference data may be received, for example, from data storage system(s) 125. In some embodiments, customer preference data may be received at step 402 along with the at least one actor parameter. Customer preference data may include data relating to actors that the operation owner blocks, avoids, prefers, or chooses.

If the operation owner blocks an actor, that actor will not be associated with the operation, regardless of the suitability score of that actor (e.g., even if no other actors meet the predetermined threshold, the blocked actor will not be selected at step 410). In some embodiments, the blocked actor may never be added to the preliminary group of suitable actors at step 408, regardless of the suitability score of the blocked actor. In some embodiments, the blocked actor may be eliminated from method 400 entirely by the actor data associated with the blocked actor not being received at step 402.

If the operation owner avoids an actor, the avoided actor is only associated with the operation if no other actor satisfies the predetermined threshold at step 408. That is, even if the avoided actor has the highest suitability score of all actors considered, the operation will be associated with another actor having a lower suitability skill that also satisfies the predetermined threshold. If only the avoided actor meets the predetermined threshold, the avoided actor may be associated with the operation. In some embodiments, the operation owner must approve the avoided actor before the avoided actor is associated with the operation.

If the operation owner prefers an actor, the preferred actor will automatically be selected from the preliminary group of suitable actors generated at step 408. That is, so long as the preferred actor meets the predetermined threshold, the preferred actor will be selected over non-preferred actors, even in non-preferred actor(s) have a higher suitability score than the preferred actor. If two of more preferred actors are contained in the preliminary group, the preferred actor with the highest suitability score may be selected.

If the operation owner chooses an actor, the chosen actor is automatically associated with the operation so long as the chosen actor submitted a posting in response to an available operation. The chosen actor may be selected even if the suitability score of the chosen actor does not satisfy the predestined threshold.

FIG. 5 illustrates an exemplary process 500 for automatically associating the operation with one of the actors in the preliminary group of suitable actors. In some embodiments, various step of the process 500 may be performed concurrently with or intermixed with the step of the process 400. At step 502, the process includes receiving an operation intent. The operation intent may include one or more of several attributes, such as cost, speed, and/or quality. In some embodiments, the operation intent is received. The operation intent may be received, for example, from the data storage system 125 of FIG. 1. In some embodiments, step 502 may be performed contemporaneously with step 402 of process 400, such that actor data and the operation intent are received together in a single transfer from the data storage system 125 (or other source).

At step 504, if the operation intent is “cost”, the process 500 proceeds to step 506, which includes receiving a bid (i.e. the monetary amount for performing the operation) from each of the actors in the preliminary group of suitable actors. In some embodiments, step 504 may be performed contemporaneously with step 402 of process 400, such that actor data and the bids are received together in a single transfer from the data storage system 125 (or other source).

At step 508, the process 500 includes automatically associating the operation with one of the actor, based on the posting received at step 506. For example, the operation may be associated with the actor who provided the posting with the lowest cost. It is noted that the actor who provided the posting with the lowest cost need not be the actor with the highest suitability score, and may in some instances even be the actor with the lowest suitability score within the preliminary group of suitable actors. However, the predetermined threshold used in step 408 of the process 400 ensures that all actors within the preliminary group of suitable actors will provide an acceptable level of competence for performing the operation.

In some embodiments, if multiple actors submitted a posting with the same lowest cost, the actor with the highest suitability score (from among those actors who posted the lowest cost) is automatically associated with the job. In some embodiments, if multiple actors posted the same lowest cost and have highest suitability score, one or more of the actor parameters may be used as a tie-breaker. For example, the operation may be assigned to the actor ranking the lowest in “Associated Operations/Application” (operation parameter 704l of FIGS. 7A-7B) in order to bring that actor on par with other actors in the amount of operations to which that actor is associated.

Referring back to step 504, if the operation intent does not include “cost”, the process 500 proceeds to step 510, which includes associating the operation with one of the actors based on the suitability score of the actors determined at step 406 of the process 400. In some embodiments, the operation is associated with the actor having the highest suitability score from within the preliminary group of suitable actors.

In general, any process, method, or step thereof discussed in this disclosure that is understood to be computer-implementable, such as the processes illustrated in FIGS. 3, 4, and 5, may be performed by one or more processors of a computer system, such any of the systems or devices in the environment 100 of FIG. 1, as described above. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

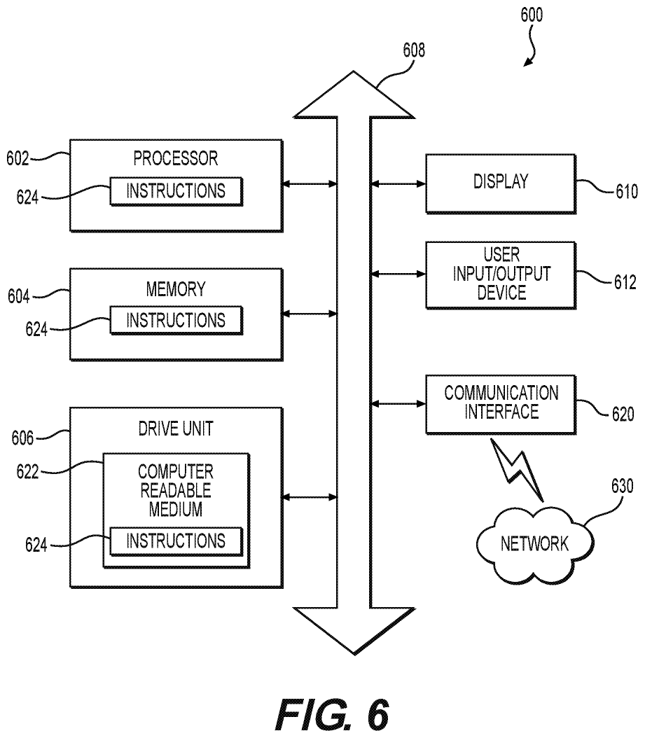

FIG. 6 is a simplified functional block diagram of a computer 600 that may be configured as a device for executing the methods of FIGS. 3, 4, and 5, according to exemplary embodiments of the present disclosure. For example, the computer 600 may be configured as the operation association system 145 and/or another system according to exemplary embodiments of this disclosure. In various embodiments, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications (e.g., via the network 630). The computer 600 may also have a memory 604 (such as RAM) storing instructions 624 for executing techniques presented herein, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and particular functions may be interchanged among functional blocks. Steps may be added to or deleted from methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for associating at least one actor of a plurality of actors with an operation using machine learning, the method comprising:
receiving actor data comprising at least one actor parameter corresponding to at least one operation parameter of the operation;
determining a weightage score for each of the at least one actor parameters for each of the at least one actors using a trained machine-learning model;
determining a suitability score for each of the at least one actors based on the weightage scores;
generating a preliminary group of suitable actors comprising each of the at least one actors having a suitability score satisfying a predetermined threshold; and
transmitting, to a portal viewable by at least one of the actors, a selection of at least one actor from the preliminary group of suitable actors to be associated with the operation,
wherein one or more of the at least one operation parameters is predictive of a predetermined distribution of operations across the plurality of actors, and
wherein the trained machine-learning model has been trained based on historical actor data and historical evaluations associated with the historical actor data to learn associations between the historical actor data and the historical evaluations, so that the trained machine-learning model is configured to use the learned associations to determine each weightage score based on the actor data.

2. The method of claim 1, wherein the weightage score for each of the actor parameters is a numerical value in a predetermined range.

3. The method of claim 2, wherein the predetermined range of the weightage score for a first of the actor parameters is different than the predetermined range of the weightage for a second of the actor parameters.

4. The method of claim 1, wherein the suitability score for each actor comprises a summation of the weightage scores for each of the actor parameters of that actor.

5. The method of claim 1, wherein the predetermined threshold is a percentage of a maximum possible value of the suitability score.

6. The method of claim 1, further comprising:
adjusting the predetermined threshold until a desired number of actors satisfy the predetermined threshold.

7. The method of claim 1, wherein the at least one operation parameter comprises at least one of:
a size of the actor;
a number of open or in-progress operations currently associated with the actor relative to the size of the actor;
a number of open or in-progress operations currently associated with the actor;
a number of open applications relative to the size of the actor;
a number of operations associated with the actor relative to a number of operations for which the actor applied for; or
a length of time the actor has been using a system for associating the actor to an operation.

8. The method of claim 1, further comprising:
updating the actor parameters in response to an occurrence of an actionable event.

9. The method of claim 1, wherein the weightage score for at least one of the actor parameters is based on an intent of the operation, and
wherein the intent comprises at least one of cost, speed, and quality.

10. The method of claim 1, wherein the selected actor from the preliminary group of suitable actors is the actor having the highest suitability score.

11. A system for associating at least one actor of a plurality of actors with an operation using machine learning, the system comprising:
a memory having processor-readable instructions stored therein; and
one or more processors configured to access the memory and execute the processor-readable instructions, which when executed by the one or more processors configures the one or more processors to perform a plurality of functions, including functions for:
receiving actor data comprising at least one actor parameter corresponding to at least one operation parameter of the operation;
determining a weightage score for each of the at least one actor parameters for each of the at least one actors using a trained machine-learning model;
determining a suitability score for each of the at least one actors based on the weightage scores;
generating a preliminary group of suitable actors comprising each of the at least one actors having a suitability score satisfying a predetermined threshold; and
transmitting, to a portal viewable by at least one of the actors, a selection of at least one actor from the preliminary group of suitable actors to be associated with the operation,
wherein one or more of the at least one operation parameters is predictive of a predetermined distribution of operations across the plurality of actors, and
wherein the trained machine-learning model has been trained based on historical actor data and historical evaluations associated with the historical actor data to learn associations between the historical actor data and the historical evaluations, so that the trained machine-learning model is configured to use the learned associations to determine each weightage score based on the actor data.

12. The system of claim 11, wherein the weightage score for each of the actor parameters is a numerical value in a predetermined range, and
wherein the predetermined range of the weightage score for a first of the actor parameters is different than the predetermined range of the weightage for a second of the actor parameters.

13. The system of claim 11, wherein the suitability score for each actor comprises a summation of the weightage scores for each of the actor parameters of that actor.

14. The system of claim 11, wherein the predetermined threshold is a percentage of a maximum possible value of the suitability score.

15. The system of claim 11, wherein the plurality of functions further comprises:
adjusting the predetermined threshold until a desired number of actors satisfy the predetermined threshold.

16. The system of claim 11, wherein the at least one operation parameter comprises at least one of:
a size of the actor;
a number of open or in-progress operations currently associated with the actor relative to the size of the actor;
a number of open or in-progress operations currently associated with the actor;
a number of open applications relative to the size of the actor;
a number of operations associated with the actor relative to a number of operations for which the actor applied for; or
a length of time the actor has been using a system for associating the actor to an operation.

17. The system of claim 11, wherein the plurality of functions further comprises:
updating the actor parameters in response to occurrence of an actionable event.

18. The system of claim 11, wherein the weightage score for at least one of the actor parameters is based on an intent of the operation, and
wherein the intent comprises at least one of cost, speed, and quality.

19. The system of claim 11, wherein the selected actor from the preliminary group of suitable actors is the actor having the highest suitability score.

20. A computer-implemented method for associating at least one actor of a plurality of actors with an operation using machine learning, the method comprising:
receiving actor data comprising at least one actor parameter corresponding to at least one operation parameter of the operation;
determining a weightage score for each of the at least one actor parameters for each of the at least one actors using a trained machine-learning model;
determining a suitability score for each of the at least one actors based on the weightage scores, wherein the suitability score for each actor comprises a summation of the weightage scores for each of the actor parameters of that actor;
generating a preliminary group of suitable actors comprising each of the at least one actors having a suitability score satisfying a predetermined threshold, wherein the predetermined threshold is a percentage of a maximum possible value of the suitability score; and
transmitting, to a portal viewable by at least one of the actors, a selection of at least one actor from the preliminary group of suitable actors to be associated with the operation,
wherein the weightage score for at least one of the actor parameters is based on an intent of the operation, the intent comprising at least one of cost, speed, and quality,
wherein the weightage score for each of the actor parameters is a numerical value in a predetermined range, and the predetermined range of the weightage score for a first of the actor parameters is different than the predetermined range of the weightage for a second of the actor parameters,
wherein one or more of the at least one operation parameters is predictive of a predetermined distribution of operations across the plurality of actors, and
wherein the trained machine-learning model has been trained based on historical actor data and historical evaluations associated with the historical actor data to learn associations between the historical actor data and the historical evaluations, so that the trained machine-learning model is configured to use the learned associations to determine each weightage score based on the actor data.
